(19) United States
(12) Patent Application Publication
(10) Pub. No.: US 2015/0127469 A1
(43) Pub. Date: May 7, 2015

(54) RESERVE PRICE MODELING FOR ONLINE ADVERTISING AUCTIONS

(71) Applicant: LinkedIn Corporation, Mountain View, CA (US)

(72) Inventors: Tingting Cui, Mountain View, CA (US); Deepak Dileep Kumar, Mountain View, CA (US); Ashvin Kannan, Mountain View, CA (US); Deepak Agarwal, Sunnyvale, CA (US); Souvik Ghosh, San Jose, CA (US); Sohil Maru, Santa Clara, CA (US); Gururaj Seetharama, Sunnyvale, CA (US)

(73) Assignee: LinkedIn Corporation, Mountain View, CA (US)

(21) Appl. No.: 14/071,502

(22) Filed: Nov. 4, 2013

(51) Int. Cl. G06Q 30/02

(52) U.S. Cl. CPC G06Q 30/0275
USPC 705/14.71

(57) ABSTRACT

The disclosed embodiments provide a system that manages online advertising. During operation, the system calculates an intrinsic value of an online advertisement slot from at least one of a user engagement value and a cannibalization value. Next, the system obtains a reserve price for the online advertisement slot from at least one of the intrinsic value and an advertiser value. Finally, the system uses the reserve price to manage serving of online advertisements from a set of advertising campaigns in the online advertisement slot.

### RELATED APPLICATION

The subject matter of this application is related to the subject matter in a co-pending non-provisional application by inventors Souvik Ghosh, Tingting Cui, Gururaj Seetharama, Sohil Maru, Deepak Agarwal, Deepak Dileep Kumar and Ashvin Kannan and filed on the same day as the instant application, entitled “Bid Suggestions for Online Advertising Auctions,” having serial number TO BE ASSIGNED, and filed on 4 Nov. 2013 (Attorney Docket No. LI-P0258.LNK.US).

### BACKGROUND

1. Field

The disclosed embodiments relate to online advertising. More specifically, the disclosed embodiments relate to techniques for modeling reserve prices for online advertising auctions.

2. Related Art

Online advertising is associated with a significant portion of Internet activity and content. Online advertisements may be served using a variety of web-based mechanisms, including emails, search engines, websites, social media, and/or mobile applications. In turn, the online advertisements may be used by various parties to earn income, advertise products or services, and/or provide public information. For example, an advertiser may run advertising campaigns on a website such as a search engine, social media website, and/or e-commerce website to increase exposure to the goods, services, and/or information advertised in the advertising campaigns. In return, the website may receive revenue from the advertiser for serving advertisements from the advertising campaigns to users and/or causing the users to click on the advertisements.

Online advertising is also frequently targeted to users based on the users' demographics, interests, and/or behavioral patterns. Such targeted advertising may allow advertisers to more easily and/or efficiently reach users who are likely to respond to the products, services, and/or information offered by the advertisers, thereby potentially increasing the impact of the advertisers' advertising campaigns and reducing overhead and/or costs over those of non-targeted advertising campaigns.

To allow multiple advertisers to run advertising campaigns within a limited space on a website, the website may run an advertising auction, in which the advertisers bid to show their online advertisements in an online advertisement slot on the website. An online advertisement may be selected for serving in the online advertisement slot based on the attributes of the user viewing the online advertisement slot, the relevance of the advertisement to the user, and/or the bids of advertisers competing for targeting the online user through advertising in the online advertisement slot. An advertiser may thus have an unsuccessful advertising campaign if the advertiser does not provide an appropriate bid for the advertising auction and/or fails to target the right audience with the advertising campaign.

Consequently, online advertising may be facilitated by mechanisms for improving the targeting of users by online advertisements and/or bidding in advertising auctions associated with the online advertisements.

### BRIEF DESCRIPTION OF THE FIGURES

FIG. 1 shows a schematic of a system in accordance with the disclosed embodiments.

FIG. 2 shows a system for managing online advertising in accordance with the disclosed embodiments.

FIG. 3 shows the calculation of a reserve price for an online advertisement slot in accordance with the disclosed embodiments.

FIG. 4 shows the creation of a set of bid suggestions for advertising campaigns associated with a user segment in accordance with the disclosed embodiments.

FIG. 5 shows an exemplary screenshot in accordance with the disclosed embodiments.

FIG. 6 shows a flowchart illustrating the process of managing online advertising using a reserve price in accordance with the disclosed embodiments.

FIG. 7 shows a flowchart illustrating the process of managing online advertising using one or more bid suggestions in accordance with the disclosed embodiments.

FIG. 8 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

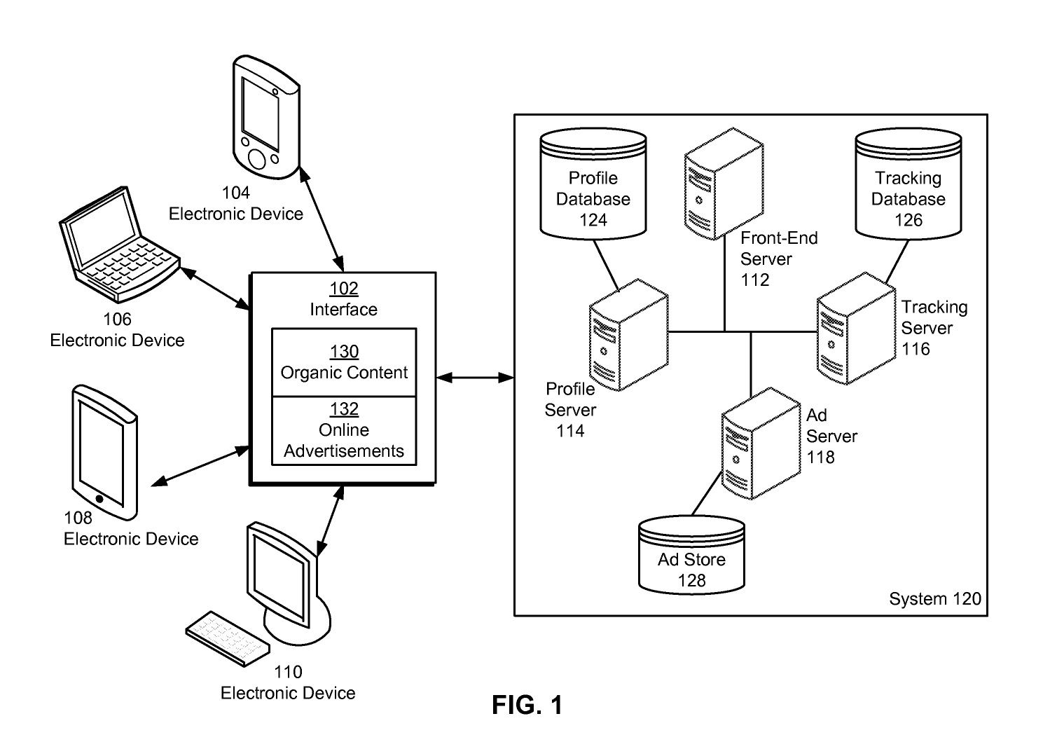

The disclosed embodiments provide a method and system for managing online advertising. As shown in FIG. 1, the online advertising may be enabled by a system 120 that serves online advertisements 132 through an interface 102 that is accessed by a set of electronic devices 104-110. For example, interface 102 may be a graphical user interface (GUI), web-based user interface, and/or other type of user interface that is provided by a web browser, mobile application, native application, and/or other application executing on a mobile phone, personal computer, laptop computer, personal digital assistant, tablet computer, portable media player, and/or other type of network-enabled electronic device.

Within interface 102, online advertisements 132 may be shown along with organic content 130. For example, a search engine may match a set of search terms to both sponsored online advertisements 132 and organic search results from the Internet. The search engine may then display both the sponsored content and organic content within the same interface 102 to users of electronic devices 104-110. In another example, a social and/or professional networking website may include online advertisements 132 in predefined regions (e.g., the sides) of interface 102 and/or intersperse online advertisements 132 among pieces of organic content 130 (e.g., posts, updates, shares, etc.) generated by users of the social and/or professional networking website.

Within system 120, profile server 114 may use profile database 124 to maintain user profiles of users of a service (e.g., social networking service, portal site, search engine, web application, etc.) hosted by system 120. A user's profile may include a set of attributes, such as personal (e.g., gender, age range), professional (e.g., job title, employer, industry, experience, skills, professional endorsements), social (e.g., organizations of which the user is a member, geographic area of residence), and/or educational (e.g., degree, university attended) attributes.

Requests for content from electronic devices 104-110 through interface 102 may be received at front-end server 112 and matched to the user profiles of users making the requests (e.g., through electronic devices 104-110). The requests may then be processed and/or tracked using one or more components of system 120, as described in further detail below.

Tracking server 116 may monitor and record activity of system 120 (e.g., in tracking database 126) and users of system 120. For example, whenever content is served from front-end server 112 (e.g., to one or more electronic devices 104-110), tracking server 116 may record the content (e.g., organic content 130, online advertisements 132, etc.) served, the user to whom the content was served, and the time at which the content was served. Tracking server 116 may also record user actions regarding content items presented to the users. For example, tracking server 116 may identify the user performing an action (e.g., using an identifier for the user), the action performed by the user (e.g., ad click, ad conversion, etc.), and/or the content item on which the action was performed (e.g., using an ad or content identifier).

Ad server 118 may maintain one or more repositories (e.g., ad store 128) of online advertisements (e.g., online advertisements 132) for serving to users and responding to ad requests from front-end server 112. Online advertisements 132 may be stored in ad store 128 with attributes, characteristics, and/or other information describing one or more target audiences of online advertisements 132. For example, a provider of an online advertisement may identify specific attributes of users targeted by the advertisement, such as the users' locations, industries, functions, skills, backgrounds, organizations, titles, and/or seniorities. When selecting an online advertisement to serve in response to a request, ad server 118 may match attributes of the user associated with the request with one or more online advertisements targeting a subset of the user's attributes in ad store 128. In other words, ad server 118 may identify a user segment containing a set of attributes that match those of the user's and retrieve online advertisements targeting the user segment from ad store 128.

Those skilled in the art will appreciate that multiple online advertisements may compete for serving to a user in an online advertisement slot. To resolve the competition, ad server 118, front-end server 112, and/or another component of system 120 may run an advertising auction, in which advertisers bid on impressions or clicks of their online advertisements by a user segment using the online advertisement slot. A winner of the advertising auction may be selected each time a request for content to be served in the online advertisement slot is received. In addition, the winner may be selected based on the bids associated with the online advertisements, the overall budgets of the advertisers placing the bids, and/or the relevance of the online advertisements to the particular user from which the request was received.

However, advertisers may lack information that facilitates successful bidding in the advertising auction. For example, an advertiser may initially submit a bid that is too low to win many (or any) auctions, thereby preventing or limiting the serving of online advertisements from the advertiser in interface 102. The advertiser may also not be aware of the low bid until analytics data shows that the online advertisements are not being served. The advertiser may then be required to manually “adjust” the bid until the desired amount of exposure is reached through the online advertisements.

At the same time, system 120 may want to prevent online advertisements 132 from cannibalizing user engagement with organic content 130 and/or maintain an “intrinsic value” of all content shown through interface 102. System 120 may further wish to increase advertiser satisfaction by guiding advertiser behavior toward winning bids, and in turn, more successful advertising campaigns.

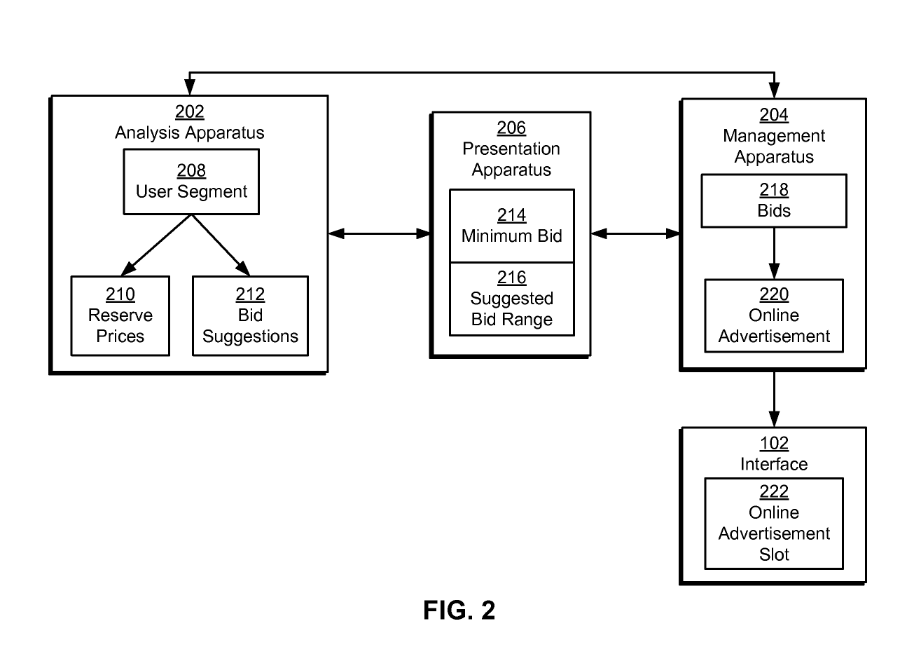

In one or more embodiments, system 120 includes functionality to manage online advertising through interface 102 using one or more mechanisms for processing and/or influencing bids from ad campaigns associated with online advertisements 132. As shown in FIG. 2, an analysis apparatus 202 may identify a user segment 208 to be targeted by one or more advertising campaigns and/or online advertisements (e.g., online advertisements 132 of FIG. 1). As mentioned above, user segment 208 may include one or more attributes of users, such as the users' locations, functions, skills, backgrounds, organizations, titles, and/or seniorities. User segment 208 may also include other information, such as the users' genders, ages, and/or behavioral patterns.

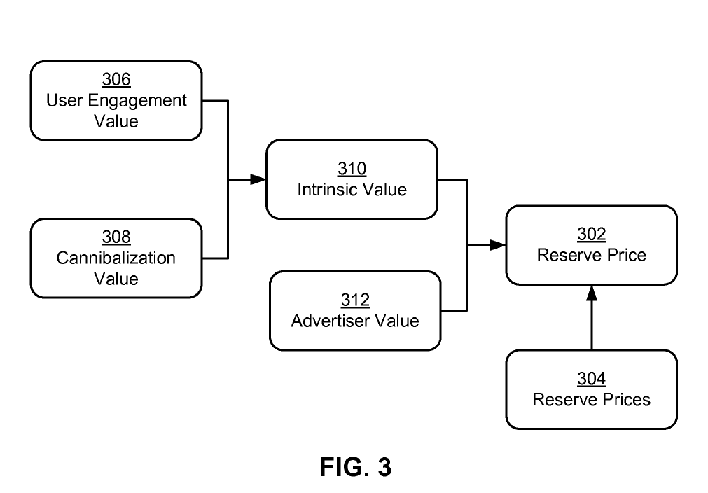

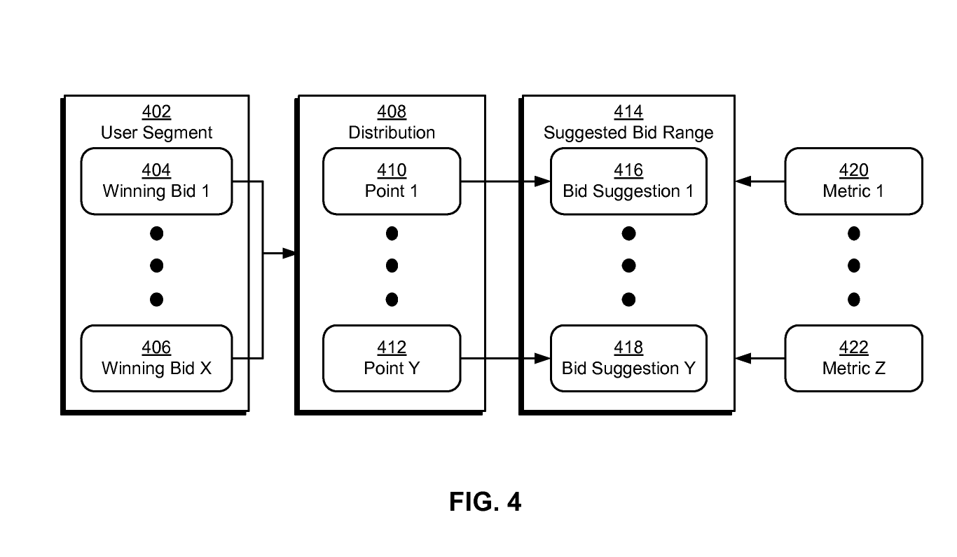

Next, analysis apparatus 202 may obtain one or more reserve prices 210 and/or one or more bid suggestions 212 for advertising auctions for serving online advertisements (e.g., online advertisement 220) within an online advertisement slot 222 in interface 102. Analysis apparatus 202 may calculate reserve prices 210 based on an intrinsic value and/or an advertiser value associated with online advertisement slot 222, as discussed in further detail below with respect to FIG. 3. Analysis apparatus 202 may additionally obtain bid suggestions 212 as one or more points from a distribution associated with winning bids for online advertisements shown to user segment 208 in online advertisement slot 222, as discussed in further detail below with respect to FIG. 4.

A presentation apparatus 206 may then provide reserve prices 210 and/or bid suggestions 212 to advertisers during setup of the advertising campaigns. More specifically, presentation apparatus 206 may display a minimum bid 214 obtained from reserve prices 210 and/or a suggested bid range 216 containing bid suggestions 212 to the advertisers. For example, presentation apparatus 206 may use interface 102 and/or another user interface to provide a set of form fields for setting up an advertising campaign. Within the user interface, presentation apparatus 206 may show minimum bid 214 and/or suggested bid range 216 next to a field for inputting a bid for an advertising campaign. Advertisers may then use minimum bid 214 and/or suggested bid range 216 as guides for placing bids for the advertising campaigns.

Each time an advertising request associated with user segment 208 is received (e.g., from a user in user segment 208) through interface 102, management apparatus 204 may run an advertising auction and select online advertisement 220 for serving in online advertisement slot 222 based on bids 218 from advertising campaigns associated with user segment 208. For example, management apparatus 204 may select a winning online advertisement 220 from the advertiser with the highest bid and an advertising budget that has not yet been exhausted (e.g., by user impressions or clicks). Alternatively, management apparatus 204 may select online advertisement 220 based on a combination of bids 218 and a set of quality scores related to the relevance of the online advertisements to user segment 208.

In addition, management apparatus 204 may use reserve prices 210 to manage the serving of online advertisements (e.g., online advertisement 220) from the advertising campaigns in online advertisement slot 222. For each advertising auction associated with user segment 208, management apparatus 204 may obtain a reserve price based on one or more attributes of user segment 208 and/or the user triggering the advertising auction. The reserve price may be the same as minimum bid 214 or different from minimum bid 214. For example, the reserve price may be a “public” reserve price that is shown as minimum bid 214 to the advertisers. Alternatively, the reserve price may be a “private” reserve price that is not known by the advertisers and is used to protect the intrinsic value of online advertisement slot 222 for a specific user and/or otherwise establish a value for online advertisement slot 222.

The winning online advertisement 220 may then be served to the user in online advertisement slot 222. For example, online advertisement 220 may be shown in a region of interface 102 that is separate from organic content (e.g., organic content 130 of FIG. 1), or online advertisement 220 may be interspersed between pieces of organic content (e.g., in a “stream” of activity or a list of search results).

Because minimum bid 214 and/or suggested bid range 216 may act as guidelines for bids 218, advertisers following the guidelines may experience increased success in winning advertising auctions associated with user segment 208. In turn, the advertisers may increase exposure to the goods, services, and/or information advertised using the corresponding advertising campaigns. At the same time, reserve prices 210 and/or minimum bid 214 may maintain the quality of content shown through interface 102 and mitigate loss of user engagement with content in interface 102.

Those skilled in the art will appreciate that the system of FIG. 2 may be implemented in a variety of ways. First, analysis apparatus 202, management apparatus 204, and presentation apparatus 206 may be implemented as a single physical machine, multiple computer systems, one or more virtual machines, a grid, one or more databases, one or more filesystems, and/or a cloud computing system. Moreover, analysis apparatus 202, management apparatus 204, and presentation apparatus 206 may be implemented together and/or separately by one or more hardware and/or software components and/or layers. For example, analysis apparatus 202, management apparatus 204, and presentation apparatus 206 may be provided by ad server 118, front-end server 112, and/or other components of system 120 of FIG. 1.

FIG. 3 shows the calculation of a reserve price 302 for an online advertisement slot (e.g., online advertisement slot 222 of FIG. 2) in accordance with the disclosed embodiments. As described above, online advertisements with bids that are less than reserve price 302 may be left out of an advertising auction for the online advertisement slot. As a result, reserve price 302 may maintain user engagement, value, and/or quality associated with content to be served in the online advertisement slot.

In addition, reserve price 302 may be calculated based on a user segment defined by one or more attributes associated with users to which the online advertisements are to be served. The attributes may be provided by the advertisers during setup of advertising campaigns for advertising using the online advertisement slot. For example, an advertiser may specify a location, industry, skill set, experience level, title, function, background, and/or seniority of the user segment to target using an advertising campaign.

The attributes may further be identified during processing of a request for content (e.g., an online advertisement) to be served in the online advertisement slot. For example, the request may include an identifier for a user, which is used to retrieve attributes associated with the user and place the user into a user segment. An online advertisement may then be selected for serving in the online advertisement slot based on the bids from advertising campaigns targeting the user segment and one or more reserve prices (e.g. reserve price 302, reserve prices 304) associated with the user and/or user segment, as described below.

To calculate reserve price 302, an intrinsic value 310 of the online advertisement slot may be obtained from a user engagement value 306 and/or a cannibalization value 308. User engagement value 306 may represent the value of user interaction with content in the space reserved for online advertisement slot 222. For example, user engagement value 306 may be a dollar amount calculated based on the click-through rate (CTR) of online advertisements shown in the online advertisement slot and/or revenue obtained from user clicks on the online advertisement. Alternatively, user engagement value 306 may be derived from the consumption of organic content shown in the space reserved for the online advertisement slot instead of online advertisements. For example, a dollar amount may be assigned to a post, article, status update, search result, and/or other piece of organic content that can appear in the space based on the value associated with use of and/or interaction with the organic content by users in the user segment.

Cannibalization value 308 may represent the value associated with cannibalization of other types of advertisements by online advertisements in the online advertisement slot. Cannibalization value 308 may be used to offset the potential loss of advertising in other types of ads caused by advertising using the online advertisement slot. For example, cannibalization value 308 may mitigate cannibalization of advertising investments among banner ads, page ads, and sponsored ads in the same interface (e.g., interface 102 of FIG. 1). Consequently, cannibalization value 308 may be based on revenue from advertising campaigns for the other types of ads. For example, cannibalization value 308 may be obtained as the maximum reserve price for bidding on the other types of ads and/or an aggregation of bids associated with the other types of ads.

Intrinsic value 310 may then be calculated by combining user engagement value 306 and cannibalization value. For example, intrinsic value 310 may be obtained using the following formula:

v₀=αg(x)+(1−α)h(x)

Within the formula, v₀ may represent intrinsic value 310, g(x) may represent user engagement value 306 for a user segment x, h(x) may represent cannibalization value 308 for the user segment, and α may be a tuning parameter for balancing the linear combination of user engagement value 306 and cannibalization value 308. In other words, α may be used to increase the weight of either user engagement value 308 or cannibalization value 308 in intrinsic value 310. As with other parts of the formula, α may be based on the user segment x. For example, α may be set to protect user engagement value 306 and prevent excessive display of ads in the interface if sell-through on advertising to the user segment is high.

Reserve price 302 may then be obtained from intrinsic value 310 and/or an advertiser value 312 that represents the value of the online advertisement slot to advertisers. For example, reserve price 302 may be calculated using the following formula, which is related to the exemplary formula described above:

v*=v₀+(1−F(v*))/f(v*)

In the formula, v* may represent reserve price 302, F(v*) may represent the cumulative distribution function (CDF) of advertiser value 312 for advertisers participating in the advertising auction, and f(v*) may represent the probability density function (pdf) of advertiser value 312. Because F(v*) and f(v*) are not directly observed, F(v*) and f(v*) may be inferred from bids in the advertising auction. For example, the pdf of advertiser value 312 may be parametrically approximated and fit to a lognormal distribution. For given parameters of the distribution, Monte Carlo simulations may be implemented to generate an equilibrium bid from randomly sampled values and perform moment matching with historical bid data. The CDF of advertiser value 312 may then be calculated from the parameterized pdf.

After reserve price 302 is calculated, reserve price 302 may be provided as a minimum bid to advertisers associated with the advertising campaigns. For example, reserve price 302 may be provided to the advertisers before the advertisers submit bids for the advertising campaigns. Reserve price 302 may also be updated with a set of other reserve prices 304 for the online advertisement slot prior to providing reserve price 302 to the advertisers. For example, reserve price 302 may be calculated for a user and/or user segment with a specific set of attributes. Reserve price 302 may then be combined with other reserve prices 304 for users and/or user segments with a subset of the same attributes to obtain an “overall” reserve price that is used as the minimum bid for advertising campaigns that target the common attribute(s).

In other words, a set of reserve prices may be calculated for individual users and/or small user segments and used in advertising auctions that target the users and/or user segments. For example, a reserve price for a specific user may be calculated based on user engagement value 306, cannibalization value 308, intrinsic value 310, and/or advertiser value for that user. When a request for content to be served in the online advertisement slot is received from the user, advertising campaigns with bids that are lower than the user-specific reserve price may be removed from consideration in the advertising auction for an online advertisement to be served in response to the request.

On the other hand, user-specific reserve prices may be too complicated and/or numerous to provide to the advertisers. Instead, such reserve prices may form a set of “private” reserve prices that are applied during selection of winners of the advertising auctions. The “private” reserve prices may then be aggregated into a “public” reserve price that is shown as the minimum bid for an advertising campaign that targets a user segment containing one or more attributes shared by a set of users and/or smaller user segments. For example, the “public” reserve price for a user segment and/or advertising campaign may be calculated by obtaining a distribution of “private” reserve prices for users in the user segment targeted by the advertising campaign and applying an aggregation function to the distribution. The “public” reserve price may thus be obtained as a point from the distribution (e.g., a quantile), and bids by the advertising campaigns may be required to be above a certain percentage of the “private” reserve prices in the distribution represented by the point.

FIG. 4 shows the creation of a set of bid suggestions (e.g., bid suggestion 1 416, bid suggestion y 418) for advertising campaigns associated with a user segment 402 in accordance with the disclosed embodiments. The bid suggestions may be provided as a suggested bid range 414 containing a low value and a high value. Alternatively, the bid suggestions may be provided in a different format, such as a sample of “successful” bids and/or a set of bids accompanied by the estimated odds and/or frequencies of winning advertising auctions using the bids.

User segment 402 may include a set of users that share one or more attributes, such as demographic attributes and/or behavioral attributes. Because users in user segment 402 may be targeted differently from users in other user segments, the bid suggestions may be calculated based on the behavior of advertisers in advertising auctions that target user segment 402.

More specifically, a set of winning bids (e.g., winning bid 1 404, winning bid x 406) from advertising campaigns targeting user segment 402 may be identified, and a distribution 408 associated with the winning bids may be obtained. Distribution 408 may include the amounts of the winning bids and/or revenue from the advertising campaigns. For example, distribution 408 may include winning bids for cost-per-click (CPC) advertising campaigns and revenue for cost-per-mille (CPM) advertising campaigns.

To obtain data for populating distribution 408, a query may be used to retrieve indexed records of advertising impressions and/or clicks for users in user segment 402, and the records may be used to obtain the winning bids and/or estimate the revenue from the impressions. For example, the query may include one or more attributes of user segment 402 that are matched to dimensions in the records. Because distribution 408 may contain data for a specific user segment 402, properties and/or values associated with distribution 408 may be obtained more easily and/or efficiently than if distribution 408 were part of a complex model of historical advertiser behavior, winning bids, and/or revenue for all users and user attributes.

In addition, distribution 408 may be specified as an empirical distribution or a parameterized distribution. The empirical distribution may include all winning bids and/or revenue from advertising auctions targeting user segment 402 over a pre-specified period (e.g., a week, a month, a year, etc.), while parameters for the parameterized distribution may be estimated based on the winning bids and/or revenue. The parameterized distribution may be more efficient to store and use than the empirical distribution, while changes in distribution 408 over time may be reflected in the empirical distribution more easily than a parameterized distribution associated with a specific family of probability distributions.

Next, one or more points (e.g., point 1 410, point y 412) from distribution 408 are selected based on one or more attributes of user segment 402 and used as the bid suggestions for user segment 402. The attributes may include the size of user segment 402, demographic information (e.g., location, industry, function, skill, background, organization, title, seniority, etc.) associated with users in user segment 408, and/or behavioral patterns among users in user segment 408. For example, the demographic information may be provided by an advertiser during setup of an advertising campaign for targeting user segment 402. Next, the demographic information may be used to identify the number of users in user segment 402, the behavior of the users in user segment 402, and/or the behavior of other advertisers in targeting users in user segment 402. The points to be used as bid suggestions may then be set to increase both participation and successful bidding in advertising auctions by the advertiser.

Continuing with the above example, a small size of user segment 402 may result in an upward shift in the points used as bid suggestions to increase the visibility of the advertising campaign and facilitate targeting of a specific set of users by the advertising campaign. On the other hand, a downward shift in the points may occur if user segment 402 is relatively large and/or not frequently targeted by advertisers (e.g., if user segment 402 includes a location that has less competition among advertisers than other locations) to encourage bidding by the advertisers.

The bid suggestions and/or suggested bid range 414 may also be adjusted based on a set of metrics (e.g., metric 1 420, metric z 422) associated with advertising campaigns targeting user segment 402. The metrics may be tracked as the advertising campaigns are setup, used, and/or discontinued by advertisers. For example, the metrics may include an abandonment rate by the advertising campaigns, a number of advertising campaigns associated with user segment 402, a budget (e.g., per-campaign budget, aggregate budget for all advertising campaigns), and/or a revenue obtained from the advertising campaigns. The metrics may also include, for each advertising campaign, a bid amount (e.g., current bid, initial bid, minimum bid, maximum bid), a number of bid changes over a pre-specified period, a number of impressions over the pre-specified period, a number of clicks over the pre-specified period, and/or an amount spent over the pre-specified period.

In particular, the bid suggestions may be adjusted up or down to change and/or maintain certain values of the metrics. For example, the bid suggestions may be adjusted up or down to maintain or achieve a certain abandonment rate, overall budget, and/or revenue from the advertising campaigns. The bid suggestions may also be adjusted for individual advertising campaigns based on the metrics associated with the advertising campaigns. For example, an advertiser with low numbers of impressions and/or clicks and/or a high number of bid changes may have trouble identifying an appropriate bid. As a result, suggested bid range 414 may be narrowed and/or the bid suggestions may be increased or decreased to steer the advertiser toward a bid that is more likely to win in an advertising auction against other bids targeting the same user segment 402. Finally, the bid suggestions may be increased to reflect higher historical spending and/or a large budget for the advertiser, or lowered to accommodate lower historical spending and/or a smaller budget for the advertiser.

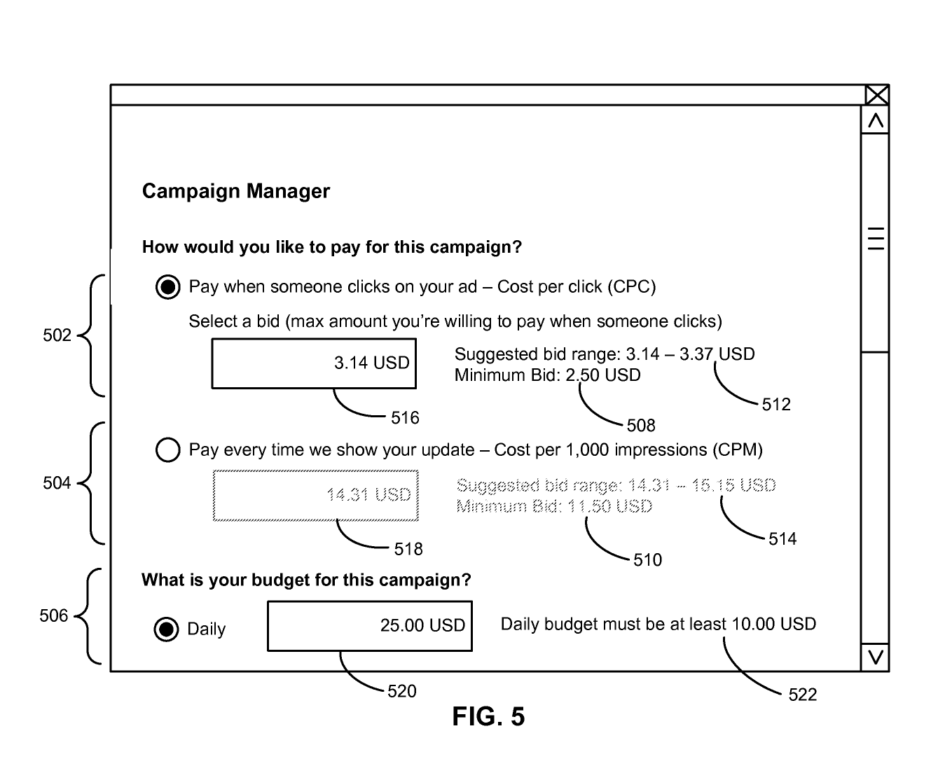

FIG. 5 shows an exemplary screenshot in accordance with the disclosed embodiments. More specifically, FIG. 5 shows a screenshot of a user interface from a presentation apparatus, such as presentation apparatus 206 of FIG. 2. The user interface may be used in setting up an advertising campaign for targeting a set of users (e.g., a user segment) with an online advertisement.

The user interface includes three sections 502-506. First, section 502 may be related to setup of a CPC advertising campaign (e.g., “Pay when someone clicks on your ad—Cost per click (CPC)”). Next, section 504 may be related to setup of a CPM campaign (e.g., “Pay every time we show your update—Cost per 1,000 impressions (CPM)”). Finally, section 506 may be related to the establishment of a budget for the advertising campaign (e.g., “What is your budget for this campaign?”).

Sections 502-504 both include a field 516-518 for providing a bid for the advertising campaign. The bid may be used in an advertising auction that selects an online advertisement for serving in an online advertisement slot from a set of online advertisements associated with advertising campaigns competing in the advertising auction.

Sections 502-504 may also provide minimum bids 508-510 and suggested bid ranges 512-514 for bids to be entered in fields 516-518. For example, section 502 may specify a $2.50 USD minimum bid 508 and a $3.14-$3.37 USD suggested bid range 512, and section 504 may specify a $11.50 USD minimum bid 510 and a $14.31-$15.15 USD suggested bid range 514. The advertiser may be required to provide a bid above minimum bids 508-510, while suggested bid ranges 512-514 may facilitate successful bidding in the advertising auction by the advertiser. In addition, minimum bids 508-510 and suggested bid ranges 512-514 differ in sections 502-504 because impressions and clicks may be valued differently.

Section 506 includes a field 520 for entering a daily budget for the advertising campaign, as well as a minimum budget 522 of $10.00 USD. The values entered into fields 516-520 may be tracked as metrics and used to update minimum bids 508-510, suggested bid ranges 512-514, and/or minimum budget 522 during subsequent access to the user interface by the advertiser and/or other advertisers. For example, the bid and/or budget provided in one or more fields 502-506 may be included in the calculation of a new minimum bid and/or suggested bid range for the advertiser and/or the other advertisers.

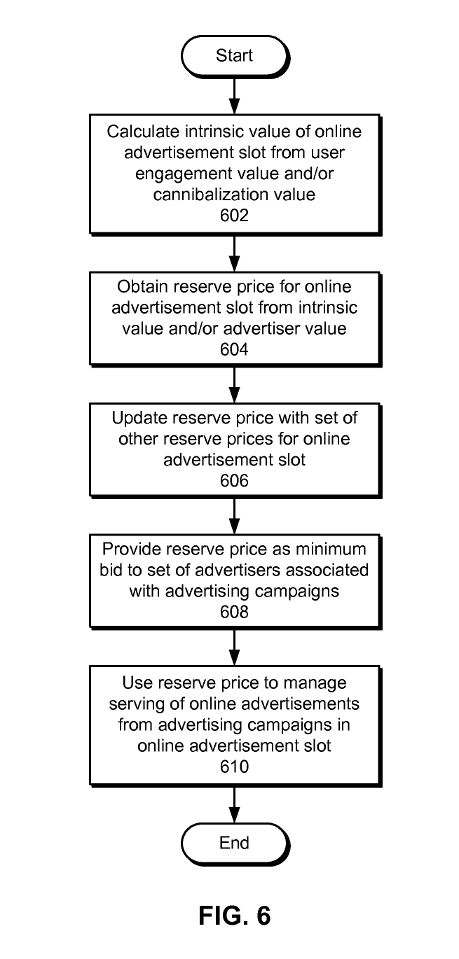

FIG. 6 shows a flowchart illustrating the process of using a reserve price to manage online advertising in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

First, the intrinsic value of an online advertisement slot is calculated from a user engagement value and/or a cannibalization value (operation 602). The user engagement value may represent the value of user consumption of other content that can be shown in the online advertisement slot, and the cannibalization value may be used to offset cannibalization of other types of online advertisements by online advertisements in the online advertisement slot. Next, a reserve price for the online advertisement slot is obtained from the intrinsic value and/or an advertiser value (operation 604) representing the value of the online advertisement slot to a set of advertisers. The advertiser value may be inferred from bids by the advertisers and include a CDF and/or a pdf of the advertiser value.

The reserve price may also be updated with a set of other reserve prices for the online advertisement slot (operation 606). For example, the reserve price may be a “private” reserve price that is calculated for a specific user and/or smaller user segment. The reserve price and a set of other “private” reserve prices for other users and/or smaller user segments may then be aggregated into a “public” reserve price for a larger user segment containing the users and/or smaller user segments.

The reserve price is then provided as a minimum bid to a set of advertisers with advertising campaigns (operation 608). The advertising campaigns may target the user segment for which the reserve price was calculated. For example, the advertising campaigns may target users with one or more common demographic and/or behavioral attributes.

Finally, the reserve price is used to manage serving of online advertisements from the advertising campaigns in the online advertisement slot (operation 610). In particular, any online advertisements associated with bids from advertising campaigns that are less than the reserve price may be removed from consideration for serving in the online advertisement slot. Consequently, the reserve price may maintain a minimum value for the online advertisement slot and/or user engagement with organic content that may be shown in lieu of online advertisements within the space reserved for the online advertisement slot.

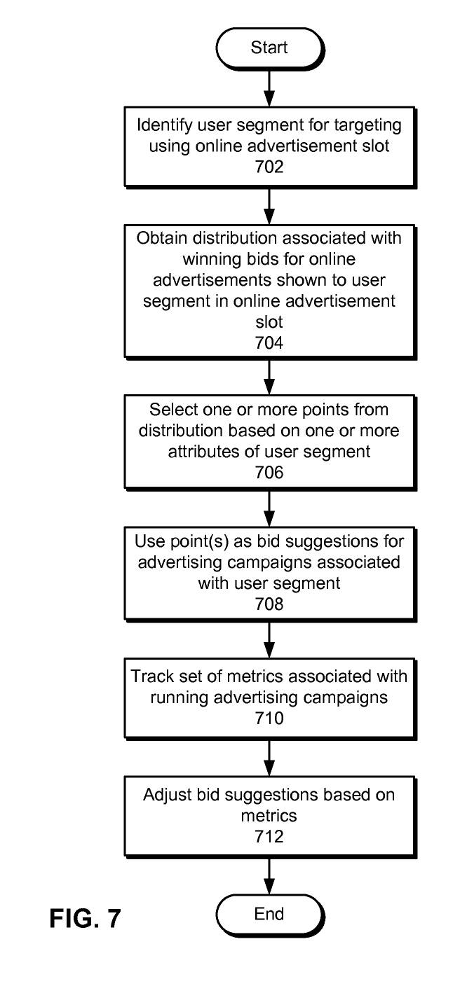

FIG. 7 shows a flowchart illustrating the process of using one or more bid suggestions to manage online advertising in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the embodiments.

Initially, a user segment for targeting using an online advertisement slot is identified (operation 702). The user segment may include attributes such as a location, an industry, a function, a skill, a background, an organization, a title, and/or a seniority. Next, a distribution associated with winning bids for online advertisements shown to the user segment in the online advertisement slot is obtained (operation 704). The distribution may be an empirical distribution or a parameterized distribution. The distribution may also include winning bids from the advertising campaigns and/or revenue from the advertising campaigns.

One or more points of the distribution are then selected based on one or more attributes of the user segment (operation 706) and used as bid suggestions for advertising campaigns associated with the user segment (operation 708). For example, the points may be selected as quartiles, deciles, percentiles, permilles, and/or other quantiles of the distribution that facilitate successful bidding by the advertising campaigns. The points may then be provided in a suggested bid range to the advertising campaigns. Alternatively, the entire distribution may be provided to guide the advertisers associated with the advertising campaigns in bidding to win a certain percentage of impressions in the user segment.

A set of metrics associated with running the advertising campaigns is also tracked (operation 710), and the bid suggestions are adjusted based on the metrics (operation 712). The metrics may include an abandonment rate, a number of advertising campaigns, a budget, a revenue, a bid amount, a number of bid changes, a number of impressions, a number of clicks, and/or an amount spent. The bid suggestions may be adjusted to achieve and/or maintain certain values for the metrics. Consequently, the bid suggestions may facilitate setup of the advertising campaigns, successful bidding by the advertising campaigns, and/or increased exposure to the goods, services, and/or information advertised by the advertising campaigns.

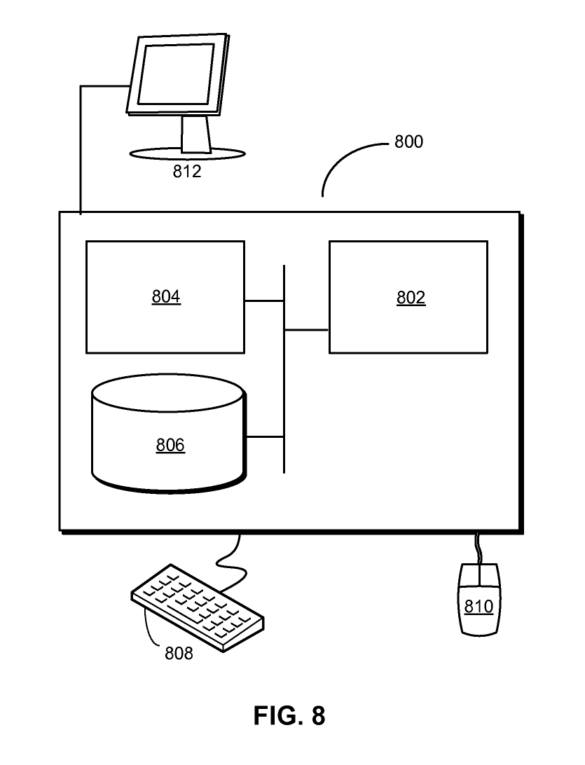

FIG. 8 shows a computer system 800 in accordance with an embodiment. Computer system 800 may correspond to an apparatus that includes a processor 802, memory 804, storage 806, and/or other components found in electronic computing devices. Processor 802 may support parallel processing and/or multi-threaded operation with other processors in computer system 800. Computer system 800 may also include input/output (I/O) devices such as a keyboard 808, a mouse 810, and a display 812.

Computer system 800 may include functionality to execute various components of the present embodiments. In particular, computer system 800 may include an operating system (not shown) that coordinates the use of hardware and software resources on computer system 800, as well as one or more applications that perform specialized tasks for the user. To perform tasks for the user, applications may obtain the use of hardware resources on computer system 800 from the operating system, as well as interact with the user through a hardware and/or software framework provided by the operating system.

In one or more embodiments, computer system 800 provides a system for managing online advertising. The system may include an analysis apparatus that first calculates an intrinsic value of an online advertisement slot from a user engagement value and/or a cannibalization value, and then obtains a reserve price for the online advertisement slot from the intrinsic value and/or an advertiser value. The system may also include a management apparatus that uses the reserve price to manage serving of online advertisements from a set of advertising campaigns in the online advertisement slot. Finally, the system may include a presentation apparatus that provides the reserve price as a minimum bid to a set of advertisers associated with the advertising campaigns.

The analysis apparatus may further identify a user segment for targeting using an online advertisement slot and obtain a distribution associated with winning bids for online advertisements shown to the user segment in the online advertisement slot. The presentation apparatus may then use one or more points from the distribution as bid suggestions for advertising campaigns associated with the user segment.

In addition, one or more components of computer system 800 may be remotely located and connected to the other components over a network. Portions of the present embodiments (e.g., analysis apparatus, management apparatus, presentation apparatus, etc.) may also be located on different nodes of a distributed system that implements the embodiments. For example, the present embodiments may be implemented using a cloud computing system that manages serving of online advertisements to a set of remote users using a set of online advertisement slots and a set of advertising campaigns competing for advertising in the online advertisement slots.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

1. A computer-implemented method for managing online advertising, comprising:
generating a public reserve price associated with advertising via an online advertisement slot by:
calculating, by computer, an intrinsic value of the online advertisement slot from at least one of a user engagement value and a cannibalization value;
calculating a first private reserve price for targeting a first user set via the online advertisement slot from at least one of the intrinsic value and an advertiser value, wherein the first user set contains users that share a first attribute set;
obtaining a second private reserve price for targeting a second user set via the online advertisement slot, wherein the second user set contains users that share a second attribute set; and
aggregating the first private reserve price with the second private reserve price to generate a public reserve price for targeting a third user set via the online advertising slot, wherein the third user set contains users that share a subset of attributes that are common to the first and second attribute sets;
providing the public reserve price as a minimum bid to a set of advertisers associated with advertising campaigns;
removing, from consideration for serving in the online advertisement slot, any online advertisements associated with bids from advertising campaigns that are less than the public reserve price; and
serving, in the online advertisement slot to a user in the third user set, an online advertisement associated with a bid from an advertising campaign that is at least equal to the public reserve price.

2-3. (canceled)

4. The computer-implemented method of claim 1, wherein the public reserve price is generated based on a distribution of the private reserve price and the other private reserve prices.

5. The computer-implemented method of claim 1, wherein the public reserve price is provided to the advertisers during setup of the advertising campaigns.

6. (canceled)

7. The computer-implemented method of claim 1, wherein the advertiser value comprises at least one of:
a cumulative distribution function; and
a probability density function.

8. The computer-implemented method of claim 1, wherein the private reserve price is associated with at least one of a user, a user segment, and an advertising campaign.

9. The computer-implemented method of claim 8, wherein the user segment is associated with at least one of a location, an industry, a function, a skill, a background, an organization, a title, and a seniority.

10. A system for managing online advertising, comprising:
an analysis apparatus configured to generate a public reserve price associated with advertising via an online advertisement slot by:
calculating an intrinsic value of the online advertisement slot from at least one of a user engagement value and a cannibalization value;
calculating a first private reserve price for targeting a first user set via the online advertisement slot from at least one of the intrinsic value and an advertiser value, wherein the first user set contains users that share a first attribute set;
obtaining a second private reserve price for targeting a second user set via the online advertisement slot, wherein the second user set contains users that share a second attribute set; and
aggregating the first private reserve price with the second private reserve price to generate a public reserve price for targeting a third user set via the online advertising slot, wherein the third user set contains users that share a subset of attributes that are common to the first and second attribute sets;
a presentation apparatus configured to provide the public reserve price as a minimum bid to a set of advertisers associated with the advertising campaigns; and
a management apparatus configured to:
remove, from consideration for serving in the online advertisement slot, any online advertisements associated with bids from advertising campaigns that are less than the public reserve price;
serve, in the online advertisement slot to a user in the third user set, an online advertisement associated with a bid from an advertising campaign that is at least equal to the public reserve price.

11-13. (canceled)

14. The system of claim 10, wherein the advertiser value comprises at least one of:
a cumulative distribution function; and
a probability density function.

15. The system of claim 10, wherein the user segment is associated with at least one of a location, an industry, a function, a skill, a background, an organization, a title, and a seniority.

16. A non-transitory computer-readable storage medium storing instructions that when executed by a computer cause the computer to perform a method for managing use of an online advertisement, the method comprising:
generating a public reserve price associated with advertising via an online advertisement slot by:
calculating an intrinsic value of the online advertisement slot from at least one of a user engagement value and a cannibalization value;
calculating a first private reserve price for targeting a first user set via the online advertisement slot from at least one of the intrinsic value and an advertiser value, wherein the first user set contains users that share a first attribute set;
obtaining a second private reserve price for targeting a second user set via the online advertisement slot, wherein the second user set contains users that share a second attribute set; and
aggregating the first private reserve price with the second private reserve price to generate a public reserve price for targeting a third user set via the online advertising slot, wherein the third user set contains users that share a subset of attributes that are common to the first and second attribute sets;
providing the public reserve price as a minimum bid to a set of advertisers associated with advertising campaigns;
removing, from consideration for serving in the online advertisement slot, any online advertisements associated with bids from advertising campaigns that are less than the public reserve price; and
serving, in the online advertisement slot to a user in the third user set, an online advertisement associated with a bid from an advertising campaign that is at least equal to the public reserve price.

17-18. (canceled)

19. The non-transitory computer-readable storage medium of claim 16, wherein the private reserve price is associated with at least one of a user, a user segment, and an advertising campaign.

20. The non-transitory computer-readable storage medium of claim 19, wherein the user segment is associated with at least one of a location, an industry, a function, a skill, a background, an organization, a title, and a seniority.
